(19) United States
(12) Patent Application Publication
(10) Pub. No.: US 2018/0138951 A1
(43) Pub. Date: May 17, 2018

(54) ANTENNA SELECTION FOR MASSIVE MIMO SYSTEMS RELATED APPLICATION

(71) Applicant: Telefonaktiebolaget LM Ericsson (publ), Stockholm (SE)

(72) Inventors: Gary BOUDREAU, KANATA (CA); Muhammad HANIF, Edmonton (CA); Seyed Hossein SEYEDMEHDI, KANATA (CA); Edward SICH, Kemptville (CA); Hong-Chuan YANG, Victoria (CA)

(21) Appl. No.: 15/831,860

(22) PCT Filed: Mar. 14, 2016
(86) PCT No.: PCT/IB2016/051452

§ 371 Date: Dec. 5, 2017

Related U.S. Application Data
(60) Provisional application No. 62/186,932, filed on Jun. 30, 2015.

(51) Int. Cl. H04B 7/0452; H04B 7/024; H04L 5/00

(52) U.S. Cl. CPC H04B 7/0452; H04B 7/024; H04B 7/0608; H04L 5/0037; H04L 5/0032

(57) ABSTRACT

A method, in a network node (20, 800) serving K scheduled user equipments (UEs), of selecting a subset of antennas from a plurality of available antennas (815) for use in communicating with the K scheduled UEs (50d) while reducing interference to Kv victim UEs (50v), each of the antennas characterized by a channel vector describing gains between the antenna on the one hand and the scheduled and victim UEs on the other hand. The method includes repeating the following steps until at least K+Kv antennas have been selected: for each antenna of a plurality of unselected antennas of the plurality of antennas, generating a composite matrix of channel gains between selected ones of the antennas including the antenna on one hand and the scheduled and victim UEs on the other hand (204); and selecting one of the plurality of unselected antennas that minimizes a function of antenna gains from the selected ones of the antennas to the scheduled and victim UEs (206). Data is transmitted (212) to the selected UEs using the selected ones of the antennas.

### RELATED APPLICATION

The present application claims the benefit of and priority to 35 U.S.C. § 371 national stage application of PCT International Application No. PCT/IB2016/051452, filed Mar. 14, 2016, which itself claims priority to U.S. Provisional Patent Application No. 62/186,932, filed Jun. 30, 2015, entitled “Antenna Selection For Massive MIMO Systems,” the disclosure of which is hereby incorporated herein by reference in its entirety.

### TECHNICAL FIELD

The present application relates to wireless communications systems, and more particularly, to antenna selection in network nodes that support multiple input multiple output (MIMO) communication.

### BACKGROUND

With the growing demands of high data rates, improved coverage and ubiquitous connectivity, cooperative multi-cell multiuser MIMO systems have emerged as a promising solution. In coordinated multiple point (CoMP) transmission (also referred to as network MIMO and collaborative MIMO), base stations (BS) of neighboring cells collaborate with one another to improve cell-edge user performance by either mitigating or nullifying inter-cell interference to users.

Based on the level of cooperation amongst BSs, CoMP can be broadly classified as joint processing/transmission (CoMPJPT) or coordinated scheduling/beamforming (CoMP-CSB). In CoMP-JPT, the neighboring BSs jointly serve users by exchanging channel state information and users' data with one another. Despite improvement in the data rates of cell-edge users, this technology is not practical due to the requirement of heavy information exchange between neighboring cells over the backhaul. CoMP-CSB, on the other hand, is a practical scheme, as it requires only partial cooperation amongst BSs for inter-cell interference (ICI) mitigation. For example, in LTE-advanced, precoding matrix indicator (PMI) coordination can be used to mitigate ICI based on the information exchanged about restricted or recommended PMIS.

Another example of CoMP-CSB is the design of a linear beamforming vector at the BS based on the channel vectors from the serving BS to the intended (and victim) users. Performance of multi-user MIMO (MU-MIMO) systems can further be improved by equipping the BSs with a large number of antennas. Such systems, also called massive MIMO (M-MIMO) systems, may provide significant improvements in link reliability, cell coverage, and/or energy and spectral efficiencies over traditional cellular systems. Due to the presence of a large number of antennas at the BS, instead of feeding back channel state information from the user equipment, the BS itself can estimate the forward link channel response by uplink pilot transmissions from the users, and by using channel reciprocity. In such a scenario, the BS of a cell can estimate gains of the channel between itself and the scheduled users in the neighboring cells, provided that they use orthogonal pilot transmission, which can be achieved by inter-cell cooperation. Furthermore, linear precoding techniques, such as zero-forcing beamforming, show near optimal performance in massive MIMO systems.

Antenna selection (AS) refers to the selection of a subset of MIMO antennas for generating a beam to a UE. Antenna selection through an exhaustive search results in best performance, but incurs a high computational burden at the BS. Therefore, some non-optimal but low complexity antenna subset selection schemes have been proposed for single cell MU-MIMO systems, including two schemes based on optimization of symbol error rate (SER-based AS) and norm of the effective channel between the BS and the scheduled users (norm-based AS). Other sub-optimal schemes to reduce the computation complexity of the SER-based and the norm-based AS schemes have been proposed, including single-QR AS and max-QR AS schemes based on Gram-Schmidt orthogonalization of the channel vectors between the BS antennas and the scheduled users, and the SNR-based AS scheme which iteratively computes an antenna subset by removing the antenna that contributes least to the individual SNR in each step. It has been shown through simulation that these three schemes (single-QR AS, max-QR AS and SNR-based AS) outperform the SER-based AS and the norm-based AS schemes in a massive MIMO setting.

### SUMMARY

Some embodiments provide a method, in a network node serving K scheduled user equipments (UEs), of selecting a subset of antennas from a plurality of available antennas for use in communicating with the K scheduled UEs while reducing interference to Kv victim UEs, each of the antennas characterized by a channel vector describing gains between the antenna the scheduled UEs and non-scheduled UEs. “Non-scheduled” UEs may reside and be scheduled in cells other than a cell served by the network node or may be physically present in a cell served by the network node but not currently be scheduled by the network node. Such UEs are generally referred to herein as “victim UEs.” The method includes repeating the following steps until at least K+Kv antennas have been selected: for each antenna of a plurality of unselected antennas of the plurality of antennas, generating a composite matrix of channel gains between selected ones of the antennas including the antenna on one hand and the scheduled and victim UEs on the other hand; and selecting one of the plurality of unselected antennas that minimizes a function of antenna gains from the selected ones of the antennas to the scheduled and victim UEs. Data is transmitted to the selected UEs using the selected ones of the antennas.

A potential advantage of this approach is that it may reduce the computational demands on base station processors, which allows antennas to be selected more quickly in a MIMO environment, thereby improving base station and network performance.

Selecting one of the plurality of unselected antennas that minimizes a function of antenna gains from the selected ones of the antennas to the scheduled and victim UEs may include selecting an antenna that minimizes the function Tr(HH^{H})⁻¹, where Tr( ) is a trace function and H is a composite matrix of channel gains between the selected antennas and the scheduled and victim UEs.

In some embodiments, selecting one of the plurality of unselected antennas that minimizes a function of antenna gains from the selected ones of the antennas to the scheduled and victim UEs may include selecting an antenna that satisfies the following equation:

$${k}^{*} = {arg min}_{i ∈ {ℐ}^{′}} \frac{1}{{\vert {a}_{ki} \vert}^{2}} ( 1 + {\sum }_{r = 1}^{k - 1} \frac{{\vert {a}_{ri} \vert}^{2}}{{\vert {a}_{{rr}^{*}} \vert}^{2}} )$$

where akᵢ are coefficients of orthonormal basis vectors that correspond to the channel vectors that describe gains between the antenna the scheduled UEs and victim UEs and I′ is the set of unselected antennas.

The function of antenna gains may correspond to an inverse of total power transmitted to the k scheduled UEs over the selected antennas.

The method may further include performing orthogonalization of the channel vectors of the selected ones of the antennas, such as by Gram-Schmidt orthogonalization.

Further embodiments provide a method, in a network node serving K scheduled user equipments (UEs), of selecting a subset of antennas from a plurality of available antennas for use in communicating with the K scheduled UEs while reducing interference to Kv victim UEs, each of the antennas characterized by a channel vector describing gains between the antenna the scheduled UEs and victim UEs. The method includes iteratively selecting one of the plurality of available antennas. For each selected antenna, generating a set of selected antennas by repeating the following steps until at least K+Kv antennas have been selected: for each antenna of a plurality of remaining unselected antennas of the plurality of antennas, generating a composite matrix of channel gains between selected ones of the antennas including the antenna on one hand and the scheduled and victim UEs on the other hand; selecting one of the plurality of unselected antennas that minimizes a function of antenna gains from the selected ones of the antennas to the scheduled and victim UEs; and selecting a set of selected antennas that results in a minimum value of total antenna gain. The method further includes transmitting data to the selected UEs using the selected ones of the antennas.

Further embodiments provide a method, in a network node serving K scheduled user equipments (UEs), of selecting a subset of antennas from a plurality of available antennas for use in communicating with the K scheduled UEs while reducing interference to Kv victim UEs, each of the antennas characterized by a channel vector describing gains between the antenna of the scheduled UEs and victim UEs. The method includes repeating the following steps until at least K antennas have been selected: for each antenna of a plurality of unselected antennas of the plurality of antennas, generating a composite matrix of channel gains between selected ones of the antennas including the antenna on one hand and the scheduled UEs on the other hand; and selecting one of the plurality of unselected antennas that minimizes a function of antenna gains from the selected ones of the antennas to the scheduled UEs.

The method further includes repeating the following steps until at least K+Kv antennas have been selected: for each antenna of a plurality of remaining unselected antennas, generating a composite matrix of channel gains between selected ones of the antennas including the antenna on one hand and the scheduled and victim UEs on the other hand; and

selecting one of the plurality of unselected antennas that minimizes a total antenna gain from the selected ones of the antennas to the scheduled and victim UEs. The method further includes transmitting data to the selected UEs using the selected ones of the antennas.

A network node serving K scheduled user equipments (UEs) includes a processor; a transceiver coupled to the processor; a plurality of antennas coupled to the transceiver; and a memory coupled to the processor. The memory includes computer readable program code embodied therein that, when executed by the processor, causes the processor to perform operations including repeating the following steps until at least K antennas have been selected: (i) for each antenna of a plurality of unselected antennas of the plurality of antennas, generating a composite matrix of channel gains between selected ones of the antennas including the antenna on one hand and the scheduled UEs on the other hand; and (ii) selecting one of the plurality of unselected antennas that minimizes a function of antenna gains from the selected ones of the antennas to the scheduled UEs.

The readable program code may further cause the processor to perform operations including repeating the following steps until at least K+Kv antennas have been selected, where Kv is a number of victim UEs: for each antenna of a plurality of unselected antennas of the plurality of antennas, generating a composite matrix of channel gains between selected ones of the antennas including the antenna on one hand and the scheduled and victim UEs on the other hand; and selecting one of the plurality of unselected antennas that minimizes a function of antenna gains from the selected ones of the antennas to the scheduled UEs and the victim UEs.

The readable program code may further cause the processor to perform operations comprising: iteratively choosing each antenna of the plurality of antennas as a starting antenna, and then repeating the steps of generating a composite matrix of channel gains between selected ones of the antennas including the antenna on one hand and the scheduled UEs on the other hand and selecting one of the plurality of unselected antennas that minimizes the function of antenna gains from the selected ones of the antennas to the scheduled UEs until at least K+Kv antennas have been selected where Kv is a number of victim UEs.

It is noted that aspects of the inventive concepts described with respect to one embodiment may be incorporated in a different embodiments although not specifically described relative thereto. That is, all embodiments and/or features of any embodiments can be combined in any way and/or combination. These and other objects and/or aspects of the present inventive concepts are explained in detail in the specification set forth below.

Other systems, methods, and/or computer program products will be or become apparent to one with skill in the art upon review of the following drawings and detailed description. It is intended that all such additional systems, methods, and/or computer program products be included within this description, be within the scope of the present inventive concepts, and be protected by the accompanying claims.

### BRIEF DESCRIPTION OF THE DRAWINGS

The accompanying drawings are included to provide a further understanding of the disclosure and are incorporated in and constitute a part of this application. In the drawings:

FIG. 1 is a schematic diagram of a wireless communication system in which embodiments of the inventive concepts may be employed.

FIG. 2 is a schematic diagram of a wireless communication system including a plurality of cells in which embodiments of the inventive concepts may be employed.

FIGS. 3, 4, 5A and 5B are flowcharts illustrating systems/methods for performing antenna selection in accordance with some embodiments of the inventive concepts.

FIGS. 6-8 are graphs that illustrate simulated performance of antenna selection systems/methods in accordance with some embodiments of the inventive concepts.

FIG. 9A is a block diagram of a network node in accordance with some embodiments of the inventive concepts.

FIG. 9B is a block diagram illustrating functional modules of a network node in accordance with some embodiments of the inventive concepts.

### DETAILED DESCRIPTION

Embodiments of the present inventive concepts now will be described more fully hereinafter with reference to the accompanying drawings. The inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive concepts. As used herein, the term “and/or” includes any and all combinations of one or more of the associated listed items.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments of the inventive concepts provide a network node that is capable of supporting massive MIMO (M-MIMO) communications. The network node can be the serving network node of an M-MIMO-capable UE or any network node with which the M-MIMO UE can establish or maintain a communication link and/or receive information (e.g. via broadcast channel).

A ‘network node’ may be any kind of network node, such as an eNodeB, Node B, Base Station, wireless access point (AP), base station controller, radio network controller, relay, donor node controlling relay, base transceiver station (BTS), transmission points, transmission nodes, RRU, RRH, nodes in distributed antenna system (DAS), core network node, MME etc.

As noted above, the term “victim UE” is used herein to refer to any UE that is not currently being scheduled by a network node under consideration. From the perspective of a network node serving a plurality of scheduled UEs in a given cell, a non-scheduled UE may reside in cells other than the cell served by the network node or may be physically present in the cell but not currently being scheduled by the network node.

The following description also uses the generic term ‘M-MIMO UE’ or simply ‘UE’. However a M-MIMO UE can be any type of wireless device that is capable of at least M-MIMO communication through wireless communication. Examples of such M-MIMO UEs include a sensor, modem, smart phone, machine type (MTC) device aka machine to machine (M2M) device, PDA, iPad, Tablet, smart phone, laptop embedded equipped (LEE), laptop mounted equipment (LME), USB dongles etc.

Although terminology from 3GPP LTE (or E-UTRAN) is used herein to describe embodiments of the inventive concepts and to describe both the serving and victim network nodes, this should not be seen as limiting the scope of the invention to only the aforementioned system. Other wireless systems, including WCDMA, UTRA FDD, UTRA TDD, and GSM/GERAN/EDGE, may also benefit from application of the systems/methods described herein. Furthermore the inventive concepts can apply to scenarios in which the serving and victim nodes employ differing radio access technologies (RATs).

In some embodiments described herein, a M-MIMO UE is configured to be served by or operate with single carrier (aka single carrier operation of the UE) for M-MIMO communication or configured to use or operate single carrier in a network node. However the inventive concepts are applicable for multi-carrier or carrier aggregation based M-MIMO communication.

One of the distinct disadvantages of using multiple antennas at the BS is increased hardware cost and software complexity at the BS. This problem gets even worse for massive MIMO systems in which hundreds of antennas can be used at the BSs.

In a M-MIMO system, a subset of the available antennas may be selected for use in communicating with a particular UE. Antenna subset selection can be used to reduce both hardware and software complexities at the BS. Judicious antenna subset selection can bring significant reduction in the hardware cost and power consumption with only a slight performance loss. Unlike antenna subset selection for point-to-point MIMO systems, which has been extensively studied, only limited results are reported for a multiuser scenario.

Embodiments of the inventive concepts provide several approaches for selecting antenna subsets from a set of available antennas. In a first embodiment, referred to herein as a “Trace-Based Antenna Selection Scheme,” the method chooses the antennas for the M-MIMO transmission based on which antennas provide a minimum contribution to a Gram-Schmidt orthogonalization procedure. In the Trace-Based AS scheme, a pool of available antennas is defined from which the selected antennas are to be chosen. In each step, an antenna with the highest corresponding channel vector norm is chosen as the next antenna from a pool of remaining available antennas, until a desired number of antennas is chosen based on the total number of desired and victim users. In the Trace-Based AS scheme, the first antenna chosen from the pool of available antennas is always the antenna with the highest corresponding channel vector norm.

In a second embodiment, referred to herein as a “Minimum Trace Based Antenna Selection Scheme,” instead of always choosing the antenna with the highest corresponding channel vector norm as the first antenna, each antenna is chosen sequentially as the first antenna in the selection process. For each choice, the remaining antennas are selected the same way as in the trace based AS scheme, which leads to M selected best antenna subsets. The M subsets are then analyzed to determine which subset is the best.

In a third embodiment, referred to herein as a “Desired Users Trace Based Antenna Selection Scheme,” the first K antennas are chosen by the trace-based AS scheme based on the channel matrix Hd only, where K is the number of desired users. The remaining Kv antennas (where Kv is the number of victim users) are then chosen to reduce/minimize the value of Tr(HH^{H})⁻¹, which as discussed below, has the effect of maximizing the total power transmitted to the k desired units over the M selected antennas.

System Model

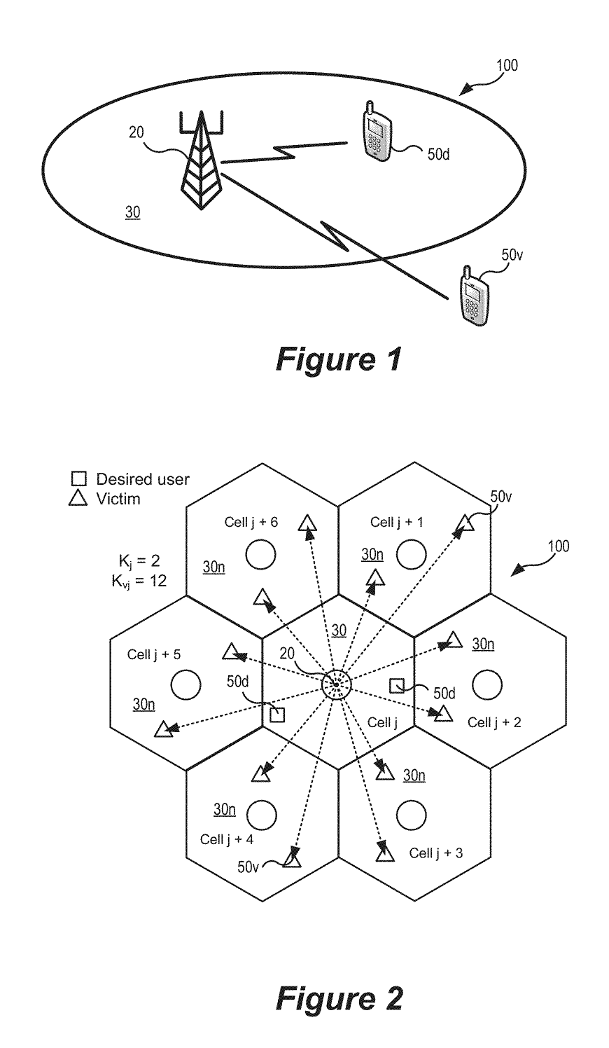

Referring to the drawings wherein like reference numbers correspond to like or similar components throughout the several figures, embodiments of the inventive concepts will be described in connection with a wireless communication system as illustrated in FIGS. 1 and 2. FIG. 1 illustrates a wireless communication system 100 including a base station 20 that serves a cell 30. The base station 20 communicates with a UE 50d that is a scheduled recipient of wireless signals transmitted by the base station 20. However, signals transmitted by the base station 20 may also be received as inter-cell interference by a “victim” UE 50v that is outside the nominal boundary of the cell 30 served by the UE 20.

FIG. 2 is a schematic illustration of a multi-cell MU-MIMO system 100 including a BS 20 that serves a jth cell 30. The cell 30 is surrounded by a plurality of neighboring cells 30n. The BS 20 is an M-MIMO capable node including Mj antennas that are available for use in communicating with scheduled UEs 50d in the cell 30.

The BS 20 simultaneously serves Kⱼ scheduled UEs 50d in the cell 30 and attempts to nullify interference caused to Kᵥⱼ victim users 50v of the neighboring cells 30n by selecting Kⱼ+Kᵥⱼ antennas out of Mⱼ available antennas, where Mⱼ is very large.

In the example illustrated in FIG. 2, there are Kⱼ=2 scheduled UEs 50d and Kᵥⱼ=12 victim UEs 50v. The terms h^{d}ᵢⱼ and h^{v}ᵢⱼ respectively denote the channel vectors between the ith BS antenna and the Kⱼ scheduled users and the Kᵥⱼ victims for the jth cell where i=1, 2, . . . Mⱼ. The composite received signal vector at the receivers' side, denoted by yⱼ, can be written as:

yⱼ=Hⱼxⱼ+nⱼ (1)

where xⱼ is the vector of transmitted symbols, nⱼ is the noise vector, and Hⱼ is the composite matrix of channel gains between the selected antennas and the users. The matrix Hⱼ can be written as:

$${H}_{j} = [ \begin{matrix}{H}_{dj} \\ {H}_{vj}\end{matrix} ] \qquad ( 2 )$$

where the matrices H_{dj} and Hᵥⱼ are the matrices of channel gains between the selected BS antennas and the intended receivers and the victim users, respectively. Let hᵢ be the ith column of the matrix H, and let Bⱼ denote the matrix of the first Kⱼ columns of the matrix Hⱼ⁻¹. The intra-cell inter-user interference amongst the intended receivers and the interference caused by the jth cell BS to the victims can be nullified by linearly precoding the data vector intended for the K scheduled users, sⱼ, as:

$${x}_{j} = \sqrt{\frac{{P}_{j}}{Tr ( {B}_{j } {B}_{j}^{H} )} {B}_{j} {s}_{j}} \qquad ( 3 )$$

where Pⱼ is the transmitted power of the jth cell's BS and Tr(⋅) is the trace function, which is the sum of the main diagonal elements of a matrix that is input as an argument to the trace function.

The trace function in the denominator of equation (3) is representative of the power scaling by the transmission channel H of each transmit antenna element. Here the scaling factor is determined by the total transmit power constraint E[x^{H}ⱼ xⱼ]=P assuming independence of unity power data symbols. The analysis assumes that the BS has perfect knowledge of the channel vectors hᵢⱼ; however, the algorithms are also valid in case of imperfect channel state information. In such scenarios, the channel state information can be provided, for example, by estimates based on reference symbol measurements, such as RSRP or RSRQ. Reference symbols that can be considered include CRS, CSI-RSRP, DMRS on the downlink and SRS on the uplink.

In some cases, the UE would measure the channel conditions on the downlink using, for example, the CRS, CSI-RSRP or DMRS. The SRS is an uplink transmission and is used by the BS to measure the uplink channel response from the UE. The SRS response, if employed for the UE implementation of the method, would have to be signaled back to the UE by the BS, adding additional signalling overhead. However, this may be avoided by assuming channel reciprocity between the uplink and downlink (i.e. estimate the uplink channel from the downlink, or vice versa) which may not be strictly true, particularly for FDD systems.

The resulting beamforming transmission will result in the same received SNR at the Kⱼ scheduled users. The sum capacity of the jth cell, C^{j}ₛᵤₘ, is given by

$${C}_{sum}^{j} = {K}_{j} {log}_{2} ( 1 + \frac{{P}_{j}}{{σ}^{2} Tr ( {B}_{j} {B}_{j}^{H} )} ) \qquad ( 4 )$$

where σ² is the noise variance at each receiver. The sum rate of the system can be maximized by properly selecting a subset of BS antennas. The best performance is obtained by selecting an antenna subset through an exhaustive search, which, for a large number of BS antennas, incurs a high computational burden. Embodiments of the inventive concepts provide antenna selection techniques that may reduce the complexity of the optimal scheme while achieving acceptable levels of performance. Application of these techniques may reduce the computational demands on base station processors, thereby improving base station performance. For the sake of clarity, the indices j in the notations related to the jth cell are omitted in the following description.

The embodiments described below are methods for finding a subset of antennas that results in small values of Tr (BB^{H}), which corresponds to the inverse of the total power transmitted to the k desired units over the M selected antennas. For that purpose, an approximation of Tr(BB^{H}) is derived. The low complexity M-MIMO antenna subset selection schemes described below are based on that approximation.

Trace Based Antenna Selection Scheme

As a basis for this approach, it is noted that B=H⁻¹L, where L=[I O]^{T}. Consequently, Tr(BB^{H})=Tr(LL^{H}(HH^{H})⁻¹) which implies that Tr(BB^{H}) is equivalent to the sum of the first K diagonal entries of (HH^{H})⁻¹. In the trace based AS method, Tr(BB^{H}) is minimized by minimizing Tr(HH^{H})⁻¹. To develop a closed-form approximation of (HH^{H})⁻¹, consider a case where K+Kᵥ=2, such that two antennas are selected at the BS for data transmission. Let h1* and h2* be the channel vectors for the chosen antennas. Based on Gram-Schmidt orthogonalization, h1* and h2* can be written as

h₁*=a₁₁u₁ (5)

h₂=a₁₂u₁+a₂₂u₂ (6)

where u1 and u2 are orthonormal vectors, and a₁₁, a₁₂ and a₂₂ are the derived coefficients for the orthonormal vectors, obtained from the Gram-Schmidt orthogonalization. For the chosen antennas, Tr (HH^{H})⁻¹ can be written as:

$${Tr ( {HH}^{H} )}^{- 1} = \frac{1}{{\vert {a}_{{11}^{*}} \vert}^{2}} + \frac{1}{{\vert {a}_{{22}^{*}} \vert}^{2}} ( 1 + \frac{{\vert {a}_{{12}^{*}} \vert}^{2}}{{\vert {a}_{{11}^{*}} \vert}^{2}} ) \qquad ( 7 )$$

In the trace-based AS scheme, the antenna that results in largest value of |a11*|² (which results in the smallest value of the first term of equation (7)) is selected as the first antenna. Then, the second antenna is chosen from the set of remaining antennas that results in the smallest value of the second term of equation (7). Note that the single-QR AS scheme, while selecting the same first antenna, will select the second antenna resulting in the largest value of |a22*|². Consequently, selection based on the trace-based AS scheme described herein would result in a lower value of Tr(HH^{H})⁻¹, and as such, better Cₛᵤₘ as compared with that for the single-QR AS scheme.

In order to generalize the trace-based AS scheme for more than two antennas, consider a case where K+Kᵥ=3 antennas are selected for transmission. In that case, the chosen channel vectors can be written in terms of orthonormal basis vectors as

h_{1*}=a₁₁u₁ (8)

h_{2*}=a₁₂u₁+a₂₂u₂ (9)

h_{3*}=a₁₃u₁+a₂₃u₂+a₃₃u₃ (10)

where u1, u2 and u3 are obtained by Gram-Schmidt orthogonalization of the vectors h1* , h2* and h3*. It can be shown that, for the chosen antennas, Tr (HH^{H})⁻¹ can be written as

$${Tr ( {HH}^{H} )}^{- 1} = \underbrace{\frac{1}{{\vert {a}_{{11}^{*}} \vert}^{2}}}_{{T}_{1}} + \underbrace{\frac{1}{{\vert {a}_{{22}^{*}} \vert}^{2}} ( 1 + \frac{{\vert {a}_{{12}^{*}} \vert}^{2}}{{\vert {a}_{{11}^{*}} \vert}^{2}} )}_{{T}_{2}} + \underbrace{\frac{1}{{\vert {a}_{{33}^{*}} \vert}^{2}} ( 1 + \frac{{\vert {a}_{{13}^{*}} - \frac{{a}_{{12}^{*}} {a}_{{28}^{*}}}{{a}_{{22}^{*}}} \vert}^{2}}{{\vert {a}_{{11}^{*}} \vert}^{2}} + \frac{{\vert {a}_{{23}^{*}} \vert}^{2}}{{\vert {a}_{{22}^{*}} \vert}^{2}} )}_{{T}_{3}} . \qquad ( 11 )$$

Based on this expression, the first and the second antennas that minimize the values of the T1 and T2 terms respectively, are selected. Since the selection procedure ensures that a12* and a23* are much smaller than a22* in magnitude after the first two antennas are selected, the term T3 may be approximated as:

$${T}_{3} \approx {T}_{3}^{′} = \frac{1}{{\vert {a}_{{33}^{*}} \vert}^{2}} ( 1 + \frac{{\vert {a}_{{13}^{*}} \vert}^{2}}{{\vert {a}_{{11}^{*}} \vert}^{2}} + \frac{{\vert {a}_{{23}^{*}} \vert}^{2}}{{\vert {a}_{{22}^{*}} \vert}^{2}} ) \qquad ( 12 )$$

This approximation not only reduces the computational complexity, but it also helps to generalize the proposed scheme for selecting more than three antennas at the BS. Specifically, in the trace-based AS scheme, the antenna that results in the minimum value of T′₃ is chosen as the third antenna. The selection procedure can be generalized to the selection of more antennas by choosing the kth antenna at the kth step (k>1) as

$${k}^{*} = {arg min}_{i ∈ {ℐ}^{′}} \frac{1}{{\vert {a}_{ki} \vert}^{2}} ( 1 + {\sum }_{r = 1}^{k - 1} \frac{{\vert {a}_{ri} \vert}^{2}}{{\vert {a}_{{rr}^{*}} \vert}^{2}} ) \qquad ( 13 )$$

Here the set I′ denotes the set of available antennas that have not been selected until the (k−1)^{st} step, and r* represents the index of the antenna chosen in the rth step. The trace-based scheme is summarized below as Algorithm 1, in which I denotes the set of selected antennas.

Algorithm 1 Trace-based AS Scheme

```

[symbol]
← {1, 2, . . . , M} [symbol]
← { }
for i ∈ [symbol]   do
  vᵢ ← hᵢ
  a₁ᵢ ← |vᵢ|
end for
for k = 1, 2, . . . , K + Kᵥ do
  Choose the ‘best’ antenna
  ${k}^{*} ← {argmin}_{i ∈ {ℐ}^{′}} \frac{1}{{\vert {a}_{ki} \vert}^{2}} ( 1 + {\sum }_{r = 1}^{k - 1} \frac{\vert {a}_{ri} \vert}{{\vert {a}_{{rr}^{*}} \vert}^{2}} )$ [symbol]
  ← [symbol]   − {k*} [symbol]
  ← [symbol]   ∪ {k*}
  Perform Gram-Schmidt Orthogonalization
  $u ← \frac{{v}_{{k}^{*}}}{{a}_{{kk}^{*}}}$
  for i ∈ [symbol]   do
  aₖᵢ ← u^{H}vᵢ
  vᵢ ← vᵢ − aₖᵢu
  a_{k+1 i} ← |vᵢ|
  end for
end for
return [symbol]
```

This algorithm may be described as follows. First each available antenna of the M available antennas is placed into a set I′ of available antennas, while the set of selected antennas, I, is initially an empty set. Next, for each antenna in the set I′ of available antennas, the quantity

$$\frac{1}{{\vert {a}_{ki} \vert}^{2}} ( 1 + {\sum }_{r = 1}^{k - 1} \frac{{\vert {a}_{ri} \vert}^{2}}{{\vert {a}_{{rr}^{*}} \vert}^{2}} )$$

is evaluated, and the antenna that results in the lowest value is selected as the next antenna by removing it from the set I′ of available antennas and placing it into the set I of selected antennas.

Gram-Schmidt othogonalization is then performed on the antenna weights. The K+Kᵥ selected antennas may then be used to transmit data to users using the antenna weights.

Minimum Trace Based Antenna Selection Scheme

In the trace-based AS scheme, the minimization of Tr(HH^{H})⁻¹ is carried out by selecting an antenna that contributes least to the approximation of Tr(HH^{H})⁻¹ in each step. However, selecting the antenna with highest corresponding channel vector norm (i.e., the antenna with the highest magnitude of the channel response) in the first step may not always result in the minimum value of Tr(HH^{H})⁻¹. In the minimum trace based AS scheme, instead of always choosing the antenna with the highest corresponding channel vector norm as the first antenna, each antenna is chosen sequentially as the first antenna. For each choice, the remaining antennas are selected the same way as in the trace based AS scheme, which leads to M selected best antenna subsets.

The antenna subset that results in the minimum value of

$${\sum }_{k = 1}^{N} \frac{1}{{\vert {a}_{{kk}^{*}} \vert}^{2}} ( 1 + {\sum }_{r = 1}^{k - 1} \frac{{\vert {a}_{{rk}^{*}} \vert}^{2}}{{\vert {a}_{{rr}^{*}} \vert}^{2}} ) \approx {Tr ( {HH}^{H} )}^{- 1} \qquad ( 14 )$$

is chosen. The detailed steps of the method are defined below as Algorithm 2.

Algorithm 2 Min-trace-based AS Scheme

```
(|h₍ᵢ₎|², Indices) ← sort (|hᵢ|², ′descend′)
minTrace ← ∞
for ind= 1, 2, . . . , M do
  Choose the first antenna
  1* = Indices(ind)
  itrTrace ← 1/|h_{1*}|² [symbol]
  ← {1, 2, . . . , M} − {1*} [symbol]
  ← {1*}
  Perform Gram-Schmidt orthogonalization
  a_{11*} ← |h_{1*}|
  $u ← \frac{{h}_{{i}^{*}}}{{a}_{{ii}^{*}}}$
  for i ∈ [symbol]   do
  a₁ᵢ ← u^{H}hᵢ
  vᵢ ← hᵢ − aₖᵢu
  a₂ᵢ ← |vᵢ|
  end for
  for k = 2, . . . , K + Kᵥ do
  Choose the ‘best’ antenna
  $( minVal , {k}^{*} ) ← {min}_{i ∈ {ℐ}^{′}} \frac{( 1 + {\sum }_{r = 1}^{k - 1} \frac{{\vert \text{?} \vert}^{2}}{{\vert {a}_{{rr}^{*}} \text{?} \vert}^{2}} )}{{\vert {a}_{ki} \vert}^{2}}$
  itrTrace ← itrTrace + minVal
  if itrTrace > minTrace then
    break
  end if [symbol]
  ← [symbol]   − {k*} [symbol]
  ← [symbol]   ∪ {k*}
  Perform Gram-Schmidt Orthogonalization
  $u ← \frac{{v}_{{k}^{*}}}{{a}_{{kk}^{*}}}$
  for i ∈ [symbol]   do
    aₖᵢ ← u^{H}vᵢ
    vᵢ ← vᵢ − aₖᵢu
    a_{k+1 i} ← |vᵢ|
  end for
  end for
  Choose the ‘best’ subset
  if itrTrace < minTrace then
  minTrace ← itrTrace [symbol]
ₘᵢₙ ← [symbol]
  end if
end for
return [symbol]  ₘᵢₙ
```

As can be seen in the foregoing, Algorithm 2 is similar to Algorithm 1, except that each antenna is iteratively selected as the first antenna, and a separate antenna subset is generated for each “first” antenna. When an antenna is chosen as the first antenna, Gram-Schmidt orthogonalization is performed on the weights of the first antenna. The remaining antennas are then successively evaluated to find the antenna that contributes the least to the approximation of Tr(HH^{H})⁻¹. The process is repeated until a subset of antennas are selected, and Gram-Schmidt orthogonalization is again performed on the selected antennas. A plurality of subsets of antennas are generated in this manner, with each antenna being selected as the first antenna. The cumulative value of the approximation of Tr(HH^{H})⁻¹ is stored for each subset as the value itrTrace, and the best antenna subset is selected as the subset with the lowest value of itrTrace.

Desired Users Trace Based Antenna Selection Scheme

Both the trace-based and the min-trace-based methods described above aim to minimize the value of Tr(BB^{H}) by minimizing the value of Tr(HH^{H})⁻¹. The antenna selection procedure in both the schemes, however, makes no distinction between the channel gains from the BS antennas to the desired users and to the victims. This indiscrimination may result in a loss in the sum capacity Cₛᵤₘ, especially when the number of the victims exceeds that of the desired users. In the desired users trace-based scheme, the first K antennas are chosen by the trace-based AS scheme based on the channel matrix Hd only.

That is, initially, the trace based algorithm described above is employed for which the H matrix consists of Hd with the Hv part set to 0. This selects the first Kj antennas based on the desired users transmissions only.

The remaining Kv antennas are then chosen to minimize the value of Tr(HH^{H})⁻¹. The details of the method for the implementation of the desired users trace-based AS scheme are given in Algorithm 3.

Algorithm 3 Desired Users Trace-based AS Scheme

```
Choose the first K antennas based on H_{d} [symbol]
← Trace-based AS(H_{d}, M, K) [symbol]
← {1, 2, . . . , M}
for i ∈ [symbol]   do
  vᵢ ← hᵢ
  a₁ᵢ ← |vᵢ|
end for
Perform Gram-Schmidt Orthogonalization
for k = 1, 2, . . . , K do [symbol]
  ← [symbol]   − {k*}
  $u ← \frac{{v}_{{k}^{*}}}{{a}_{{kk}^{*}}}$
  for i ∈ [symbol]   do
  aₖᵢ ← u^{H}vᵢ
  vᵢ ← vᵢ − aₖᵢu
  a_{k+1 i} ← |vᵢ|
  end for
end for
Select the remaining Kᵥ antennas
for k = K + 1, K + 2, . . . , K + Kᵥ do
  Choose the ‘best’ antenna
  ${k}^{*} ← {argmin}_{i ∈ {ℐ}^{′}} \frac{1}{{\vert {a}_{ki} \vert}^{2}} ( 1 + {\sum }_{r = 1}^{k - 1} \frac{\vert {a}_{ri} \vert}{{\vert {a}_{{rr}^{*}} \vert}^{2}} )$ [symbol]
  ← [symbol]   − {k*} [symbol]
  ← [symbol]   ∪ {k*}
  Perform Gram-Schmidt Orthogonalization
  $u ← \frac{{v}_{{k}^{*}}}{{a}_{{kk}^{*}}}$
  for i ∈ [symbol]   do
  aₖᵢ ← u^{H}vᵢ
  vᵢ ← vᵢ − aₖᵢu
  a_{k+1 i} ← |vᵢ|
  end for
end for
return [symbol]
```

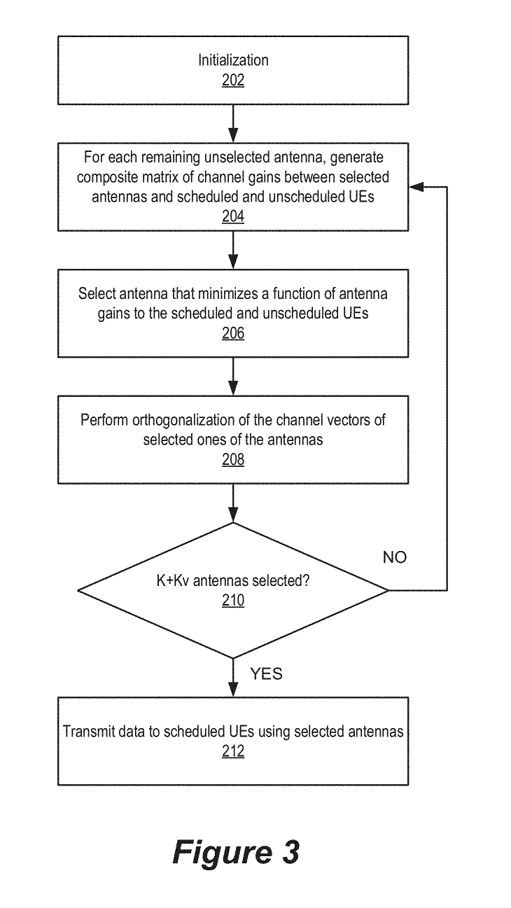

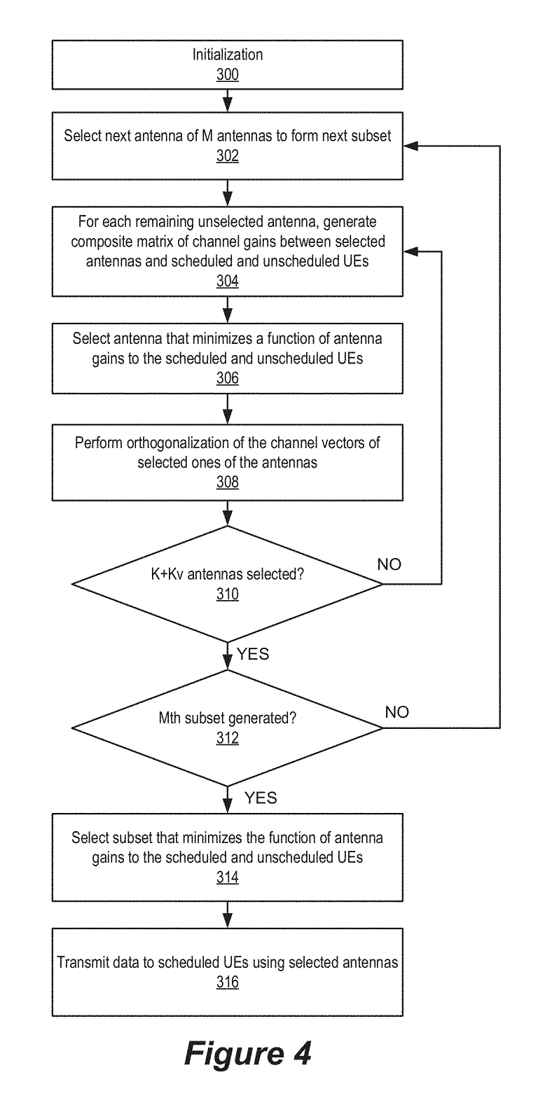

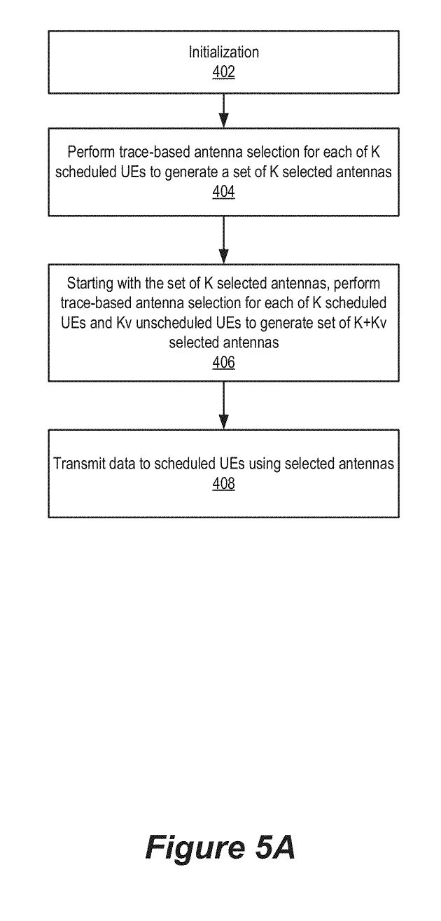

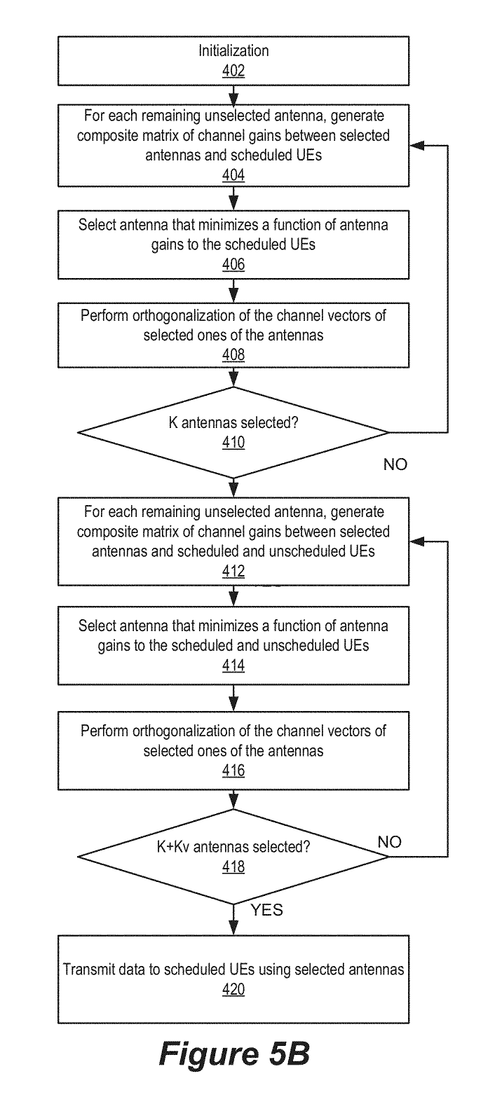

FIGS. 3-5 are flowcharts that illustrate operations according to some embodiments. In particular, FIG. 3 is a flowchart that illustrates operations associated with a trace-based AS embodiment, FIG. 4 is a flowchart that illustrates a operations associated with a minimum trace-based AS embodiment, and FIG. 5 is a flowchart that illustrates a operations associated with a desired users trace-based AS embodiment.

Referring to FIG. 3, the trace-based AS selection operations may be performed in or for a network node serving K scheduled user equipments (UEs) to select a subset of antennas from a plurality of available antennas for use in communicating with the K scheduled UEs while reducing interference to Kv victim UEs. Each of the antennas is characterized by a channel vector describing gains between the antenna the scheduled and victim UEs.

After an initialization step (block 202), the method includes, generating, for each remaining unselected antenna, a composite matrix of channel gains between selected ones of the antennas including the antenna on one hand and the scheduled and victim UEs on the other hand (block 204), and selecting the previously unselected antenna that minimizes a function of antenna gains from the selected antennas to the scheduled and victim UEs (block 206). Orthogonalization of the channel vectors of the selected antennas is then performed (block 208). The operations are repeated (block 210) until K+Kv antennas have been selected. The network node then transmits data to the scheduled UEs using the selected antennas (block 212).

Referring to FIG. 4, the minimum trace-based AS method includes, after an initialization step (block 300), iteratively selecting each of M available antennas as the first selected antenna (block 302). For each remaining unselected antenna, a composite matrix of channel gains between selected ones of the antennas including the antenna on one hand and the scheduled and victim UEs on the other hand is generated (block 304), and the previously unselected antenna that minimizes a function of antenna gains from the selected antennas to the scheduled and victim UEs is selected (block 306). Orthogonalization of the channel vectors of the selected antennas is then performed (block 308). The operations are repeated (block 310) until K+Kv antennas have been selected.

The foregoing steps are repeated using each of the M antennas as the first selected antenna to obtain M subsets of selected antennas. Each subset is then evaluated, and the subset that minimizes the function of antenna gains to the scheduled and victim UEs is chosen as the selected set of antennas for use by the BS. The network node then transmits data to the scheduled UEs using the selected antennas (block 316).

Referring to FIG. 5A, in the desired users trace-based AS, after initialization (block 402), trace-based antenna selection is performed for each of K scheduled UEs to generate a set of K selected antennas (block 404). Then, starting with the set of K selected antennas, trace-based antenna selection is performed for each of K scheduled UEs and Kv victim UEs to generate a set of K+Kv selected antennas (block 406).

The desired users trace-based AS technique is illustrated in more detail in FIG. 5B. Referring to FIG. 5B, in the desired users trace-based AS technique, after initialization (block 402), for each remaining unselected antenna, a composite matrix of channel gains between selected ones of the antennas including the antenna on one hand and the scheduled UEs on the other hand is generated (block 404), and the previously unselected antenna that minimizes a function of antenna gains from the selected antennas to the scheduled and victim UEs is selected (block 406). Orthogonalization of the channel vectors of the selected antennas is then performed (block 408). The operations are repeated (block 210) until K antennas have been selected.

Next, for each remaining unselected antenna, a composite matrix of channel gains between selected ones of the antennas including the antenna on one hand and the scheduled and victim UEs on the other hand is generated (block 412), and the previously unselected antenna that minimizes a function of antenna gains from the selected antennas to the scheduled and victim UEs is selected (block 414). Orthogonalization of the channel vectors of the selected antennas is then performed (block 416). The operations are repeated (block 418) until K+Kv antennas have been selected.

The network node then transmits data to the scheduled UEs using the selected antennas (block 420).

Simulation Results

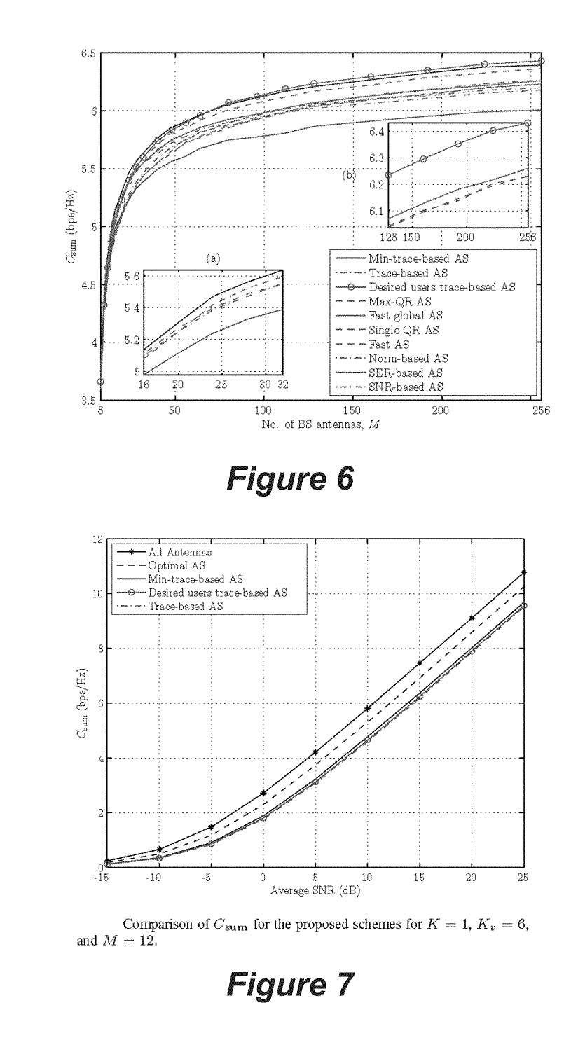

FIG. 6 shows behavior of the sum capacity, Cₛᵤₘ, of the proposed schemes in comparison with that of other suboptimal schemes. The simulation was implemented assuming independent and identically distributed (i.i.d) Rayleigh fading channel with an average SNR of 10 dB. Monte-Carlo simulations for 3000 trials were used to generate the plot. The capacity trends for high and low complexity AS schemes are displayed in magnified inset windows (a) and (b) respectively (see Table I for complexity comparison). FIG. 2 shows that there is a mixed behavior amongst different antenna selection schemes for small values of M. But as the number of BS antennas grows, the desired user traced-based scheme starts to outperform the others. The min-trace-based scheme shows best performance for relatively small values of M and performs slightly worse than the desired users trace-based AS scheme for large values of M. The trace-based AS scheme performs better than single-QR AS schemes for all values of M, while for norm-based, SER-based, SNR-based and fast global AS schemes, it outperforms them only for high values of M.

In fact for high enough values of M, the traced-based AS scheme's performance is only slightly poorer than the max-QR and the other proposed antenna subset selection schemes.

FIG. 7 shows trend of the sum capacity against average SNR in i.i.d Rayleigh fading. An antenna subset is chosen out of 12 available BS antennas to serve a user and cancel interference to six victims simultaneously. Quite intuitively, selecting all antennas results in best performance. Second is that of the optimal antenna selection scheme which is followed closely by the min-trace-based scheme. Desired user trace-based AS and the trace-based AS schemes show similar performance for all SNR range and perform slightly worse than the mintrace-based AS scheme. As M is small, the min-trace based AS scheme shows better performance as compared with the desired user trace-based AS scheme.

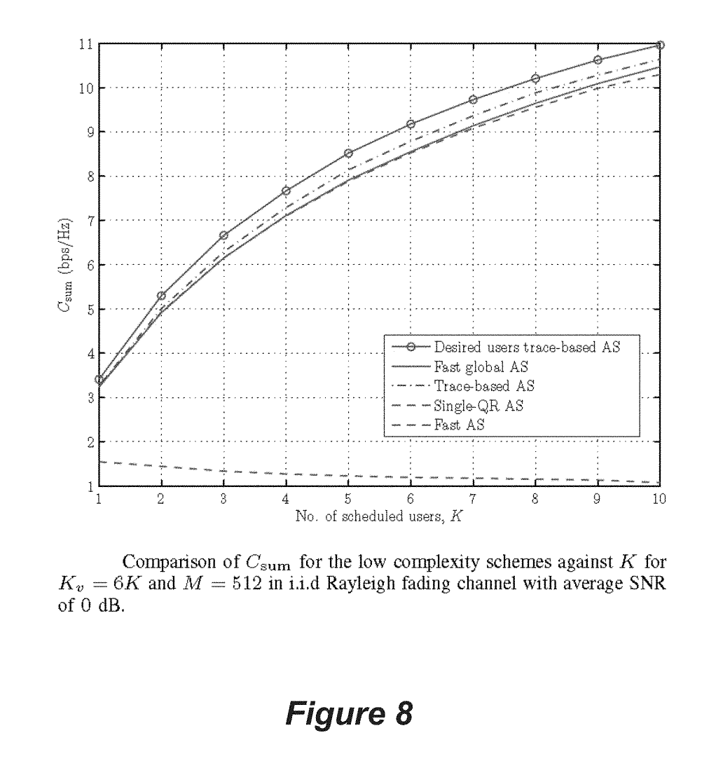

FIG. 8 shows behavior of the Cₛᵤₘ of low complexity AS schemes against number of users scheduled for transmission in a cell, K. The BS selects K+Kᵥ antennas for transmission to the scheduled users and nullification of interference to a total of Kᵥ=6K victims in the neighboring cells. Since M is large, simulations were carried out only for low complexity AS schemes. The trace-based AS scheme outperforms all other schemes except the desired users trace based scheme, which excels over all others. Fast AS scheme performs the worst while the single-QR and the fast global AS schemes have almost same capacities.

Table I shows computational complexities of the simulated antenna subset selection algorithms. The algorithms with the least computational complexity are tabulated above the algorithms with higher computational complexities. Amongst all the sub-optimal AS schemes, the desired user trace-based AS scheme shows least sensitivity to the number of BS antennas, M, and achieves best performance in massive MIMO setting.

TABLE I
COMPLEXITIES OF DIFFERENT ANTENNA
SUBSET SELECTION SCHEMES.

| Algorithm | Complexity |
|---|---|
| Trace-based AS | O(M(K + Kᵥ)²) |
| Desired Users Trace-based AS | O(M(K + Kᵥ)²) |
| Fast AS | O(M(K + Kᵥ)²) |
| Single-QR AS | O(M(K + Kᵥ)²) |
| Fast Global AS | O(TM(K + Kᵥ)²) * |
| Min-trace-based AS | O(M2(K + Kᵥ)²) |
| Max-QR AS | O(M2(K + Kᵥ)²) |
| SNR-based AS | O((M − K − Kᵥ)M²(K + Kᵥ)²) |
| SER-based AS | O((M − K − Kᵥ)M³(K + Kᵥ)) |
| Norm-based AS | O((M − K − Kᵥ)M³(K + Kᵥ)) |
| Optimal | O(MK + Kᵥ (K + Kᵥ)³) |

* T is the number of iterations taken by the algorithm.

Hardware and computation complexities of a cooperative multiple point transmission systems can be significantly reduced by judicious antenna subset selection at the base station of a cell. Embodiments of the inventive concepts provide three sub-optimal antenna subset selection schemes based on minimization of the trace of a matrix. The proposed desired users trace-based antenna subset selection schemes, while having lowest complexity order, outperforms all other sub-optimal antenna subset schemes in a massive MIMO setting.

The M-MIMO antenna selection methods described herein may enable a M-MIMO UE to more efficiently achieve a targeted throughput while employing a reduced complexity implementation. In addition, the M-MIMO antenna selection methods described herein may achieve close to optimal throughput and/or may have superior performance to known reduced complexity antenna selection algorithms, while also having lower complexity. The M-MIMO antenna selection methods described herein may also enable a WAN to achieve high spectral efficiency in existing networks. The antenna selection algorithms described herein can be implemented practically through use of existing channel feedback signaling in the LTE network.

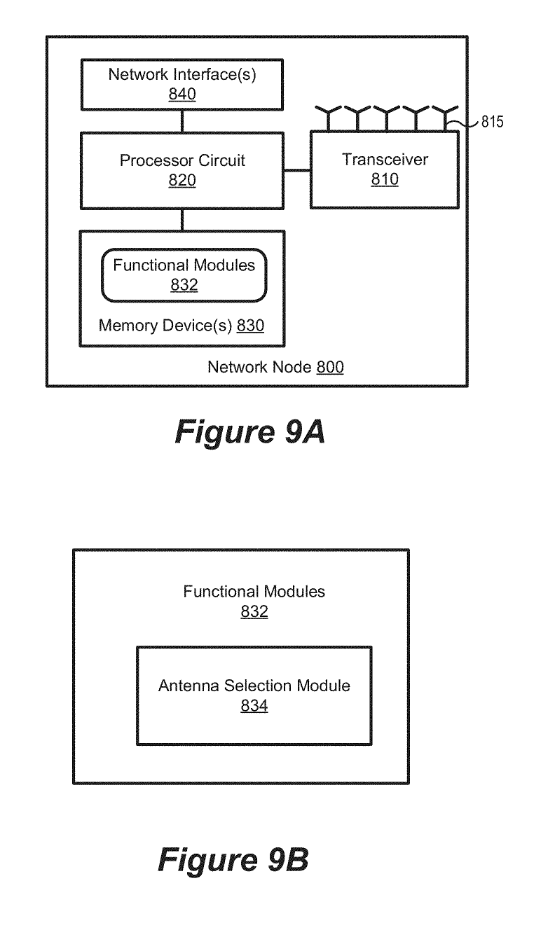

FIG. 9A is a block diagram of a network node 800 that is configured according to one or more embodiments disclosed herein for a radio network node, an access node, or other network node. The network node 800 can include a transceiver 810, a network interface(s) 840, a processor circuit(s) 820 (referred to as processor for brevity), and a memory device(s) 830 (referred to as memory for brevity) containing functional modules 832.

The transceiver 810 is configured to communicate with the UE 100 using one or more of the radio access technologies disclosed herein, when the network node 800 is a radio network node. The processor 820 may include one or more data processing circuits, such as a general purpose and/or special purpose processor, e.g., microprocessor and/or digital signal processor, that may be collocated or distributed across one or more networks. The processor 820 is configured to execute computer program instructions from the functional modules 832 of the memory device(s) 830 to perform at least some of the operations and methods of described herein as being performed by a network node. The network interface 840 communicates with other network nodes and/or a core network.

FIG. 9B is a block diagram that illustrates the functional modules 832 of the memory 830 in more detail. As shown therein, the functional modules 832 may include an antenna selection module 834 that is configured to perform the operations described above for the trace based antenna selection method, the minimum trace based antenna selection method and/or the desired users trace based antenna selection method.

### ABBREVIATIONS

UE User Equipment

WAN Wireless Access Network

M-MIMO Massive MIMO

PLMN Public Land Mobile Network

MIMO Multiple Input-Multiple Output

AS Antenna Selection

RSRP Reference Signal Received Power

RSRQ Reference Signal Received Quality

CRS Cell-specific Reference Signals

CSI-RS Channel State Information Reference Signal

DMRS Demodulation Reference Signal

SRS Sounding Reference Signal

DL Downlink

UL Uplink

SNR Signal to Noise Ratio

As will be appreciated by one of skill in the art, the present inventive concepts may be embodied as a method, data processing system, and/or computer program product. Furthermore, the present inventive concepts may take the form of a computer program product on a tangible computer usable storage medium having computer program code embodied in the medium that can be executed by a computer. Any suitable tangible computer readable medium may be utilized including hard disks, CD ROMs, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments and, although specific terms are employed, they are used in a generic and descriptive sense only and not for purposes of limitation, the scope of the inventive concepts being set forth in the following claims.

1. A method, in a network node (20, 800) serving K scheduled user equipments (UEs), of selecting a subset of antennas from a plurality of available antennas (815) for use in communicating with the K scheduled UEs (50d) while reducing interference to Kv victim UEs (50v), each of the antennas characterized by a channel vector describing gains between the antenna and the scheduled and victim UEs, the method comprising:
(i) repeating the following steps until at least K+Kv antennas have been selected:
for each antenna of a plurality of unselected antennas of the plurality of antennas, generating a composite matrix of channel gains between selected ones of the antennas including the antenna on one hand and the scheduled and victim UEs on the other hand (204); and
selecting one of the plurality of unselected antennas that minimizes a function of antenna gains from the selected ones of the antennas to the scheduled and victim UEs (206); and
(ii) transmitting data to the selected UEs using the selected ones of the antennas (212).

2. A method according to claim 1, wherein selecting one of the plurality of unselected antennas that minimizes a function of antenna gains from the selected ones of the antennas to the scheduled and victim UEs comprises selecting an antenna that minimizes the function Tr(HH^{H})⁻¹, where Tr( ) is a trace function and H is a composite matrix of channel gains between the selected antennas and the scheduled and victim UEs.

3. A method according to claim 1 or 2, wherein selecting one of the plurality of unselected antennas that minimizes a function of antenna gains from the selected ones of the antennas to the scheduled and victim UEs comprises selecting an antenna that satisfies the following equation:
$${k}^{*} = {arg min}_{i ∈ {ℐ}^{′}} \frac{1}{{\vert {a}_{ki} \vert}^{2}} ( 1 + {\sum }_{r = 1}^{k - 1} \frac{{\vert {a}_{ri} \vert}^{2}}{{\vert {a}_{{rr}^{*}} \vert}^{2}} )$$
where aₖᵢ are coefficients of orthonormal basis vectors that correspond to the channel vectors that describe gains between the ith antenna and the scheduled and victim UEs and I′ is the set of unselected antennas.

4. A method according to any previous claim, wherein the function of antenna gains corresponds to an inverse of total power transmitted to the k scheduled UEs over the selected antennas.

5. A method according to any previous claim, further comprising performing orthogonalization of the channel vectors of the selected ones of the antennas (208).

6. A method according to any previous claim, wherein performing orthogonalization of the channel vectors of the selected ones of the antennas comprises performing Gram-Schmidt orthogonalization of the channel vectors of the selected ones of the antennas.

7. A method, in a network node serving K scheduled user equipments (UEs), of selecting a subset of antennas from a plurality of available antennas for use in communicating with the K scheduled UEs while reducing interference to Kv victim UEs, each of the antennas characterized by a channel vector describing gains between the antenna the scheduled and victim UEs, the method comprising:
(i) iteratively selecting one of the plurality of available antennas (302);
(ii) for each selected antenna, generating a set of selected antennas by repeating the following steps until at least K+Kv antennas have been selected:
for each antenna of a plurality of remaining unselected antennas of the plurality of antennas, generating a composite matrix of channel gains between selected ones of the antennas including the antenna on one hand and the scheduled and victim UEs on the other hand (304);
selecting one of the plurality of unselected antennas that minimizes a function of antenna gains from the selected ones of the antennas to the scheduled and victim UEs (306); and
selecting a set of selected antennas that results in a minimum value of total antenna gain (314); and
(iii) transmitting data to the selected UEs using the selected ones of the antennas (316).

8. A method according to claim 7, wherein selecting one of the plurality of unselected antennas that minimizes a function of antenna gains from the selected ones of the antennas to the scheduled and victim UEs comprises selecting an antenna that minimizes the function Tr(HH^{H})⁻¹, where Tr( ) is a trace function and H is a composite matrix of channel gains between the selected antennas and the scheduled and victim UEs.

9. A method according to claim 7 or 8, wherein selecting one of the plurality of unselected antennas that minimizes a function of antenna gains from the selected ones of the antennas to the scheduled and victim UEs comprises selecting an antenna that satisfies the following equation:
$${k}^{*} = {arg min}_{i ∈ {ℐ}^{′}} \frac{1}{{\vert {a}_{ki} \vert}^{2}} ( 1 + {\sum }_{r = 1}^{k - 1} \frac{{\vert {a}_{ri} \vert}^{2}}{{\vert {a}_{{rr}^{*}} \vert}^{2}} )$$
where aₖᵢ are coefficients of orthonormal basis vectors that correspond to the channel vectors that describe gains between the ith antenna and the scheduled and victim UEs, and I′ is the set of unselected antennas.

10. A method according to any of claims 7 to 9, wherein the function of antenna gains corresponds to an inverse of total power transmitted to the k scheduled UEs over the selected antennas.

11. A method according to any of claims 7 to 10, further comprising performing orthogonalization of the channel vectors of the selected ones of the antennas (308).

12. A method according to claim 11, wherein performing orthogonalization of the channel vectors of the selected ones of the antennas comprises performing Gram-Schmidt orthogonalization of the channel vectors of the selected ones of the antennas.

13. A method, in a network node serving K scheduled user equipments (UEs), of selecting a subset of antennas from a plurality of available antennas for use in communicating with the K scheduled UEs while reducing interference to Kv victim UEs, each of the antennas characterized by a channel vector describing gains between the antenna and the scheduled and victim UEs, the method comprising:
(i) repeating the following steps until at least K antennas have been selected:
for each antenna of a plurality of unselected antennas of the plurality of antennas, generating a composite matrix of channel gains between selected ones of the antennas including the antenna on one hand and the scheduled UEs on the other hand (404); and
selecting one of the plurality of unselected antennas that minimizes a function of antenna gains from the selected ones of the antennas to the scheduled UEs (406);
(ii) repeating the following steps until at least K+Kv antennas have been selected:
for each antenna of a plurality of remaining unselected antennas, generating a composite matrix of channel gains between selected ones of the antennas including the antenna on one hand and the scheduled and victim UEs on the other hand (412); and
selecting one of the plurality of unselected antennas that minimizes a total antenna gain from the selected ones of the antennas to the scheduled and victim UEs (414); and
(iii) transmitting data to the selected UEs using the selected ones of the antennas (420).

14. A method according to claim 13, wherein selecting one of the plurality of unselected antennas that minimizes a function of antenna gains from the selected ones of the antennas to the scheduled and victim UEs comprises selecting an antenna that minimizes the function Tr(HH^{H})⁻¹, where Tr( ) is a trace function and H is a composite matrix of channel gains between the selected antennas and the scheduled and victim UEs.

15. A method according to claim 13 or 14, wherein selecting one of the plurality of unselected antennas that minimizes a function of antenna gains from the selected ones of the antennas to the scheduled and victim UEs comprises selecting an antenna that satisfies the following equation:
$${k}^{*} = {arg min}_{i ∈ {ℐ}^{′}} \frac{1}{{\vert {a}_{ki} \vert}^{2}} ( 1 + {\sum }_{r = 1}^{k - 1} \frac{{\vert {a}_{ri} \vert}^{2}}{{\vert {a}_{{rr}^{*}} \vert}^{2}} )$$
where aₖᵢ are coefficients of orthonormal basis vectors that correspond to the channel vectors that describe gains between the ith antenna and the scheduled and victim UEs and I′ is the set of unselected antennas.

16. A method according to any of claims 13-15, wherein the function of antenna gains corresponds to an inverse of total power transmitted to the k scheduled UEs over the selected antennas.

17. A network node serving K scheduled user equipments (UEs), the network node comprising:
a processor (820);
a transceiver (810) coupled to the processor;
a plurality of antennas (815) coupled to the transceiver
a memory (830) coupled to the processor, the memory comprising computer readable program code embodied therein that, when executed by the processor, causes the processor to perform operations comprising:
repeating the following steps until at least K antennas have been selected:
for each antenna of a plurality of unselected antennas of the plurality of antennas, generating a composite matrix of channel gains between selected ones of the antennas including the antenna on one hand and the scheduled UEs on the other hand; and
selecting one of the plurality of unselected antennas that minimizes a function of antenna gains from the selected ones of the antennas to the scheduled UEs.

18. A network node according to claim 17, wherein the computer readable program code further causes the processor to perform operations comprising:
repeating the following steps until at least K+Kv antennas have been selected, where Kv is a number of victim UEs:
for each antenna of a plurality of unselected antennas of the plurality of antennas, generating a composite matrix of channel gains between selected ones of the antennas including the antenna on one hand and the scheduled and victim UEs on the other hand;
selecting one of the plurality of unselected antennas that minimizes a function of antenna gains from the selected ones of the antennas to the scheduled UEs and the victim UEs.

19. A network node according to claim 17 or 18, wherein the computer readable program code further causes the processor to perform operations comprising:
iteratively choosing each antenna of the plurality of antennas as a starting antenna, and then repeating the steps of generating a composite matrix of channel gains between selected ones of the antennas including the antenna on one hand and the scheduled UEs on the other hand and selecting one of the plurality of unselected antennas that minimizes the function of antenna gains from the selected ones of the antennas to the scheduled UEs until at least K+Kv antennas have been selected where Kv is a number of victim UEs.

20. A network node according to any of claims 17-19, wherein the function of antenna gains corresponds to an inverse of total power transmitted to the k scheduled UEs over the selected antennas.
